(19) United States
(12) Patent Application Publication
(10) Pub. No.: US 2007/0070267 A1
(43) Pub. Date: Mar. 29, 2007

(54) Liquid crystal display panel with zigzag-shaped pixel color filters

(75) Inventor: Chiu-Lien Yang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/526,533

(22) Filed: Sep. 25, 2006

(30) Foreign Application Priority Data
Sep. 23, 2005 (TW) 94133038

(51) Int. Cl. G02F 1/1335

(52) U.S. Cl. 349/106

(57) ABSTRACT

An exemplary liquid crystal display (300) includes a first substrate (310), a second substrate (320), and a liquid crystal layer (330) between the first and second substrates. An array of color filter units (340) is formed at the first substrate, each of the color filter units being generally a zigzag-shaped. An array of pixel electrodes (350) is formed at the second substrate, at positions in one-to-one correspondence with the sub-pixel color filter units.

### FIELD OF THE INVENTION

The present invention relates to liquid crystal display panels, and more particularly to a liquid crystal display panel having a color filter with zigzag-shaped portions.

### BACKGROUND

Liquid crystal display panels (LCDs) have been widely used in the field of monitors and visual display units. For example, liquid crystal display televisions (LCD TVs), mobile phones, and portable computers use LCDs, because the LCD has advantages including lightness in weight, a thin profile, low power consumption, and low radiation. In addition, these kinds of products can provide high luminance and full color quality displays.

Referring to FIGS. 12 and 13, a conventional liquid crystal display 100 includes a first substrate 110, a second substrate 120, and a liquid crystal layer 130 interposed between the first and second substrates 110, 120. A multiplicity of color filter units 140 is formed on the first substrate 110 (in FIG. 12, a single color filter unit 140 is indicated with a branched lead line). Each color filter unit 140 includes a generally rectangular red (R) sub-pixel color filter 141, a generally rectangular green (G) sub-pixel color filter 142, a generally rectangular blue (B) sub-pixel color filter 143, and a generally rectangular white (W) sub-pixel color filter 144 arranged side by side. The color filter units 140 are arranged in a regular array, such that same-colored sub-pixel color filters 141, 142, 143, 144 of each two adjacent color filter units 140 one above the other (as viewed according to FIG. 13) are arranged end-to-end. Thereby, a same-colored sub-pixel color filter 141, 142, 143, 144 of each of multiple color filter units 140 aligned along a vertical direction forms a part of a so-called vertical stripe of the one color. A plurality of pixel electrodes 150 are formed on the second substrate 120 at positions in one-to-one correspondence with the color filter units 140 (in FIG. 12, a single pixel electrode 150 is indicated with a branched lead line).

The boundary region between any two adjacent side by side sub-pixel color filters 141, 142, 143, 144 is substantially linear. This means that the so-called color mix effect between each two adjacent sub-pixel color filters 141, 142, 143, 144 one beside the other is generally not sufficient. Thus, the liquid crystal display 100 may not be able to achieve a high level of color display quality.

Accordingly, what is needed is a liquid crystal display configured to be able to provide a high level of color display quality.

### SUMMARY

An exemplary liquid crystal display panel includes a first substrate, a second substrate, and a liquid crystal layer between the first and second substrates. A plurality of color filter units is formed at the first substrate, each of the color filter units being generally zigzag-shaped. A plurality of pixel electrodes is formed at the second substrate, at positions in one-to-one correspondence with the sub-pixel color filter units.

Another exemplary liquid crystal display panel includes a first substrate, a second substrate, a liquid crystal layer between the first and second substrates, a plurality of color filter units, and a plurality of pixel electrodes. The color filter units are formed at the first substrate, and each color filter unit having a zigzag shape. The pixel electrodes are formed at the second substrate at positions in one-to-one correspondence with the sub-pixel color filters, thereby defining a plurality of pixel regions. Each pixel region includes a transmission region and a reflection region.

A detailed description of embodiments of the present invention is given below with reference to the accompanying drawings.

### BRIEF DESCRIPTION OF THE DRAWINGS

Embodiments of the invention can be more fully understood by reading the subsequent detailed description and examples with references made to the accompanying drawings. In the drawings, all the views are schematic.

FIG. 1 is a side cross-sectional view of part of a liquid crystal display panel in accordance with a first embodiment of the present invention, the liquid crystal display panel including a plurality of color filter units.

FIG. 2 is a top plan view of one of the color filter units of the liquid crystal display panel of FIG. 1.

FIG. 3 is a top plan view of an alternative embodiment of the color filter unit shown in FIG. 2.

FIG. 4 is a side cross-sectional view of part of a liquid crystal display panel in accordance with a second embodiment of the present invention, the liquid crystal display panel including a plurality of color filter units.

FIG. 5 is a top plan view of one of the color filter units of the liquid crystal display panel of FIG. 4.

FIG. 6 is a top plan view of an alternative embodiment of the color filter unit shown in FIG. 5.

FIG. 7 is a side cross-sectional view of part of a liquid crystal display panel in accordance with a third embodiment of the present invention, the liquid crystal display panel including a plurality of color filter units.

FIG. 8 is a top plan view of one of the color filter units of the liquid crystal display panel of FIG. 7, the color filter unit including four sub-pixel color filters.

FIG. 9 is a top plan view of an alternative embodiment of any one of the sub-pixel color filters shown in FIG. 8.

FIG. 10 is a top plan view of another alternative embodiment of any one of the sub-pixel color filters shown in FIG. 8.

FIG. 11 is a side cross-sectional view of part of a liquid crystal display according to a fourth embodiment of the present invention, the liquid crystal display including the liquid crystal display panel of FIG. 1.

FIG. 12 is a side cross-sectional view of part of a conventional liquid crystal display panel, the liquid crystal display panel including a multiplicity of color filter units.

FIG. 13 is a top plan view of one of the color filter units of the liquid crystal display panel of FIG. 12.

### DETAILED DESCRIPTION OF PREFERRED EMBODIMENTS

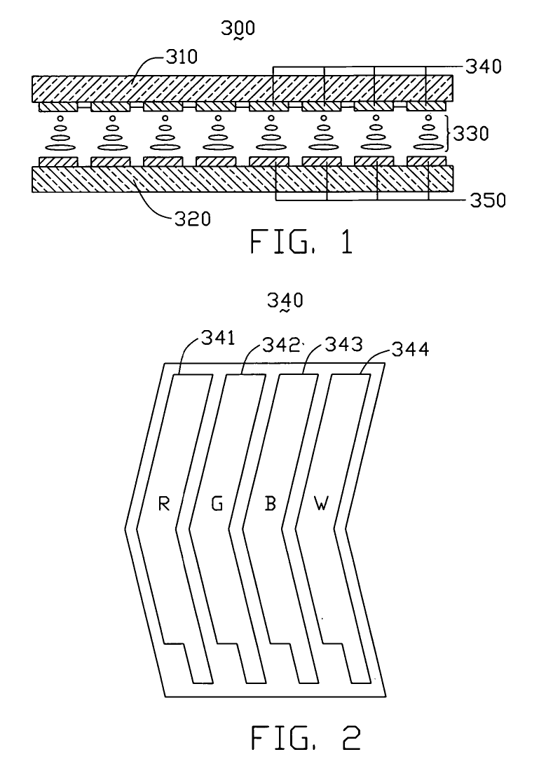

Referring to FIG. 1 and FIG. 2, a liquid crystal display panel 300 in accordance with a first embodiment of the present invention includes a first substrate 310, a second substrate 320, and a liquid crystal layer 330 interposed between the first and second substrates 310, 320. A plurality of color filter units 340 is formed on an inner surface of the first substrate 310 (in FIG. 1, a single color filter unit 340 is indicated with a branched lead line). Each color filter unit 340 includes a red (R) sub-pixel color filter 341, a green (G) sub-pixel color filter 342, a blue (B) sub-pixel color filter 343, and a white (W) sub-pixel color filter 344 arranged side by side. The color filter units 340 are arranged in a regular array, such that same-colored sub-pixel color filters 341, 342, 343, 344 of each two adjacent color filter units 340 one above the other (as viewed according to FIG. 2) are arranged end-to-end. Thereby, a same-colored sub-pixel color filter 341, 342, 343, 344 of each of plural color filter units 140 aligned along a vertical direction forms a part of a so-called vertical stripe of the one color.

Each of the sub-pixel color filters 341, 342, 343, 344 has a same generally zigzag-shaped configuration including two segments. In the illustrated embodiment, each sub-pixel color filter 341, 342, 343, 344 has a same gently zigzag-shaped configuration. Therefore each vertical stripe of the one color has a gently zigzag-shaped configuration. A plurality of pixel electrodes 350 are formed on the second substrate 320 at positions in one-to-one correspondence with the color filter units 340 (in FIG. 1, a single pixel electrode 350 is indicated with a branched lead line). Thus each of pixel regions (not labeled) of the liquid crystal display panel 300 includes a color filter unit 340 and a corresponding pixel electrode 350. The pixel electrode 350 has four sub-pixel electrodes (not labeled), which correspond to the sub-pixel color filters 341, 342, 343, 344 of the color filter unit 340, respectively. Each of the sub-pixel electrodes has a generally zigzag-shaped configuration similar to the configuration of the corresponding sub-pixel color filter 341, 342, 343, 344. The pixel electrodes 350 are made from transparent electrically conductive material, such as indium tin oxide or indium zinc oxide.

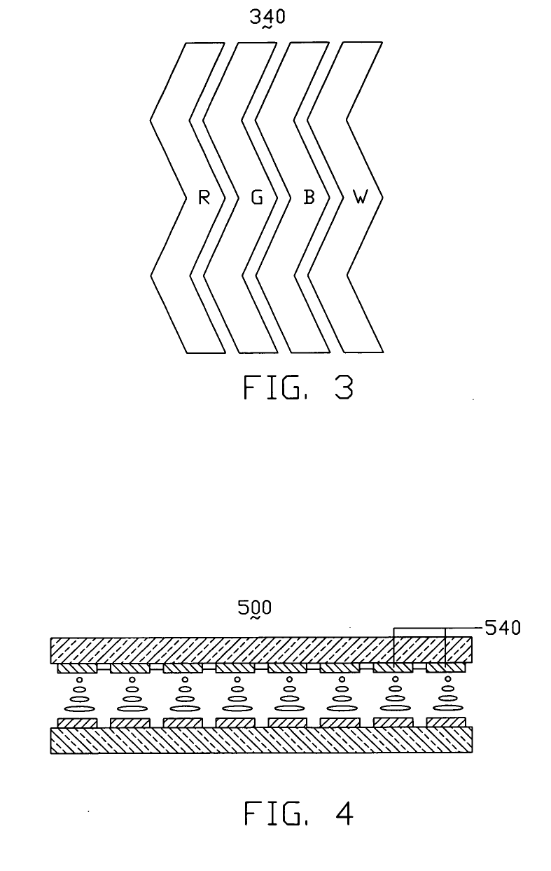

Referring to FIG. 3, in an alternative embodiment, each sub-pixel color filter 341, 342, 343, 344 of each color filter unit 340 can have a generally zigzag-shaped configuration including three or more segments.

The boundary region between each two adjacent sub-pixel color filters 341, 342, 343, 344 is generally zigzag-shaped. Accordingly, the boundary region between each two adjacent vertical stripes having different colors is generally zigzag-shaped. Thus the so-called color mixing region between each two adjacent sub-pixel color filters 341, 342, 343, 344 is increased, and the so-called color mixing region between each two adjacent vertical stripes is correspondingly increased. This means that the so-called color mix effect between each two adjacent sub-pixel color filters 341, 342, 343, 344 is improved, and the so-called color mix effect between each two adjacent vertical stripes is correspondingly improved. The result is that the color display quality of the liquid crystal display panel 300 is enhanced.

Referring to FIG. 4, part of a liquid crystal display panel according to a second embodiment of the present invention is shown. The liquid crystal display panel 500 of the second embodiment is similar to the above-described first embodiment. However, the liquid crystal display panel 500 includes a plurality of color filter units 540 (in FIG. 4, a single color filter unit 540 is indicated with a branched lead line). Referring also to FIG. 5, each color filter unit 540 includes a red (R) sub-pixel color filter 541, a green (G) sub-pixel color filter 542, a blue (B) sub-pixel color filter 543, and a white sub-pixel color filter 544 arranged in a 2×2 matrix. The red sub-pixel color filter 541 and the green sub-pixel color filter 542 are arranged side by side and are obliquely oriented along a first direction. The white sub-pixel color filter 544 and the blue sub-pixel color filter 543 are arranged side by side and are obliquely oriented along a second direction symmetrically opposite to the first direction. Thus the color filter unit 540 has a generally zigzag-shaped configuration including two segments.

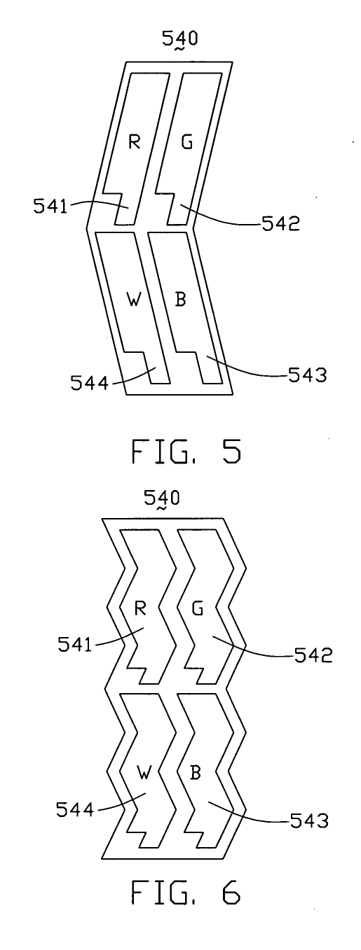

Referring to FIG. 6, in an alternative embodiment, each of the sub-pixel color filters 541, 542, 543, 544 of each color filter unit 540 can have a generally zigzag-shaped configuration including three or more segments. Thus, the color filter, unit 540 correspondingly has a generally zigzag-shaped configuration including three or more segments.

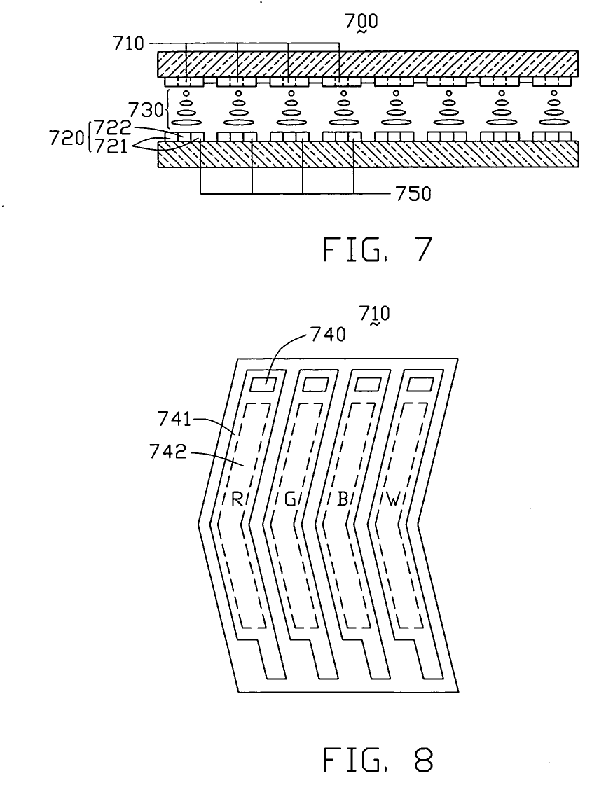

Referring to FIG. 7 and FIG. 8, these are views of parts of a liquid crystal display panel according to a third embodiment of the present invention. The liquid crystal display panel 700 of the third embodiment is similar to the above-described first embodiment. However, in the liquid crystal display panel 700, each of color filter units 710, a corresponding pixel electrode 750, and a portion of a liquid crystal layer 730 sandwiched between the color filter unit 710 and the pixel electrode 750 defines a pixel region. That is, in FIG. 7, a single color filter unit 710 is indicated with a branched lead line, and a single pixel electrode 750 is indicated with a branched lead line. Each color filter unit 710 has a red (R) sub-pixel color filter (not labeled), a green (G) sub-pixel color filter (not labeled), a blue (B) sub-pixel color filter (not labeled), and a white (W) sub-pixel color filter (not labeled) arranged side by side.

Each pixel electrode 750 has four sub-pixel electrodes 720, corresponding to the four sub-pixel color filters of a respective one of the color filter units 710. Each of the sub-pixel electrodes 720 includes a transmission portion 722 and a reflection portion 721. The transmission portion 722 corresponds to a transmission region 742 of the sub-pixel color filter, and the reflection portion 721 corresponds to a reflection region 741 of the sub-pixel color filter. In the illustrated embodiment, the transmission portion 722 is surrounded by the reflection portion 721. The reflection portion 721 has a generally zigzag-shaped configuration, and the transmission portion 722 has a generally zigzag-shaped configuration corresponding to that of the reflection portion 721. Light emitted from a backlight (not shown) under the liquid crystal display panel 700 passes through the transmission portion 722 and the corresponding transmission region 742. Light from outside of (above) the liquid crystal display panel 700 is reflected by the reflection portion 721 and passes through the corresponding reflection region 741. Each of the red, green, blue, and white sub-pixel color filters includes a through hole 740. The through holes 740 are parallelogram-shaped. The through holes 740 can increase an amount of light that passes through the sub-pixel color filters.

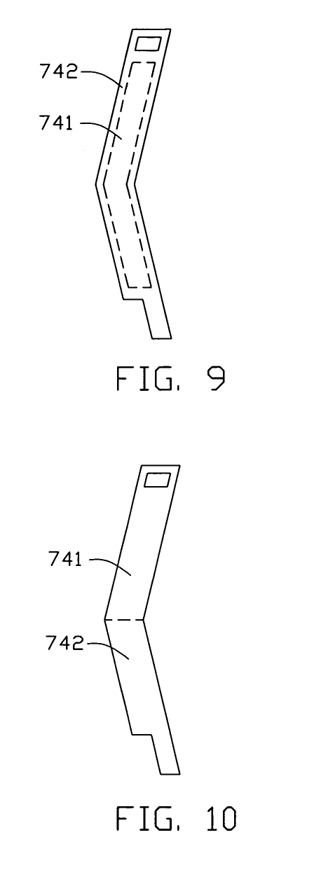

In an alternative embodiment, in each sub-pixel electrode 720, the reflection portion 721 can be surrounded by the transmission portion 722. In such case, referring to FIG. 9, in each sub-pixel color filter, the reflection region 741 is surrounded by the transmission region 742. In another alternative embodiment, in each sub-pixel electrode 720, the reflection portion 721 and the transmission portion 722 can be configured to have substantially the same size and shape, but be positioned symmetrically opposite to each other. That is, the reflection portion 721 is obliquely oriented along a first direction, and the transmission portion 722 is obliquely oriented along a second direction symmetrically opposite to the first direction. In such case, referring to FIG. 10, in each sub-pixel color filter, the reflection region 741 and the transmission region 742 have substantially the same size and shape, and are positioned symmetrically opposite to each other. That is, the reflection region 741 is obliquely oriented along the first direction, and the transmission region 742 is obliquely oriented along the second direction symmetrically opposite to the first direction. In other alternative embodiments, the through holes 740 of the sub-pixel color filters can be rectangular, circular, elliptic, ovoid, oval-shaped, etc.

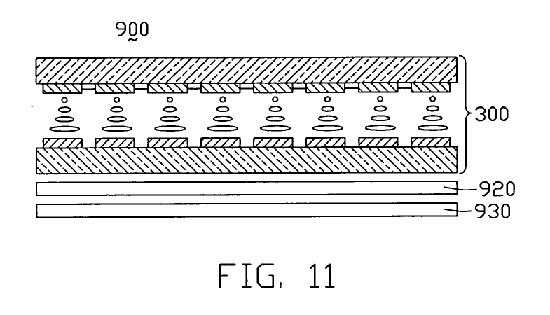

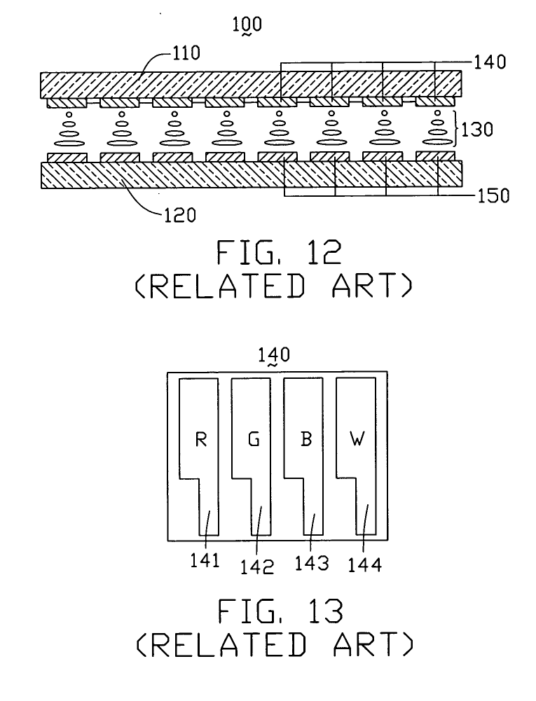

Referring to FIG. 11, this is cross-sectional view of part of a liquid crystal display according to a fourth embodiment of the present invention. The liquid crystal display 900 includes the above-described liquid crystal display panel 300, a backlight module 920, and a frame 930. The frame 930 accommodates the liquid crystal panel 300 and the backlight module 920. The backlight module 920 includes a light source (not shown), such as a cold cathode fluorescent light (CCFL). Light beams from the backlight module 920 enter the liquid crystal panel 300. The boundary region between each two adjacent color filter units 340 one beside the other of the liquid crystal panel 300 is generally zigzag-shaped, and the boundary region between each two adjacent sub-pixel color filters 341, 342, 343, 344 is generally zigzag-shaped. Thus the color mixing regions among the color filter units 340 are increased, and the color mix effect among the color filter units 340 is improved. The result is that the color display quality of the liquid crystal display 900 is enhanced.

In alternative embodiments, the liquid crystal display 900 can instead utilize the liquid crystal display panel 500 or the liquid crystal display panel 700. In each such case, the color mix effect is improved, and the color display quality is correspondingly enhanced.

While the invention has been described by way of examples and in terms of preferred embodiments, it is to be understood that the invention is not limited thereto. To the contrary, the above description is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A liquid crystal display, comprising:
a first substrate;
a second substrate;
a liquid crystal layer between the first and second substrates;
a plurality of color filter units formed at the first substrate, each of the color filter units being generally zigzag-shaped; and
a plurality of pixel electrodes formed at the second substrate at positions in one-to-one correspondence with the color filter units.

2. The liquid crystal display as claimed in claim 1, wherein each of the color filter units comprises a plurality of generally zigzag-shaped sub-pixel color filters.

3. The liquid crystal display as claimed in claim 1, wherein each of the color filter units comprises a plurality of sub-pixel color filters, wherein two of the sub-pixel color filters are positioned end to end with respect to each other, and are aligned along different directions that are symmetrically opposite to each other.

4. The liquid crystal display as claimed in claim 1, wherein each of the color filter units comprises a red sub-pixel color filter, a green pixel sub-color filter, a blue pixel sub-color filter, and a white pixel sub-color filter.

5. The liquid crystal display as claimed in claim 4, wherein in each of the color filter units, the red sub-pixel color filter, the green sub-pixel color filter, the blue sub-pixel color filter, and the white sub-pixel color filter are arranged side by side in a single row.

6. The liquid crystal display as claimed in claim 4, wherein in each of the color filter units, the red sub-pixel color filter, the green sub-pixel color filter, the blue sub-pixel color filter, and the white sub-pixel color filter are arranged in a 2×2 matrix.

7. The liquid crystal display as claimed in claim 1, wherein each of the pixel electrodes has a generally zigzag-shaped configuration corresponding to a respective one of the color filter units.

8. The liquid crystal display as claimed in claim 1, further comprising a backlight module for providing light beams to the first and the second substrates.

9. A liquid crystal display, comprising:
a first substrate;
a second substrate;
a liquid crystal layer between the first and second substrates;
a plurality of generally zigzag-shaped color filter units formed at the first substrate, each of the color filter units comprising a plurality of sub-pixel color filters; and
a plurality of generally zigzag-shaped pixel electrodes formed at the second substrate, each of the pixel electrodes comprising a plurality of sub-pixel electrodes at positions in one-to-one correspondence with the sub-pixel color filters, thereby defining a plurality of sub-pixel regions of the liquid crystal display;
wherein each of the sub-pixel regions comprises a light transmission region and a light reflection region.

10. The liquid crystal display as claimed in claim 9, wherein the sub-pixel color filters are generally zigzag-shaped.

11. The liquid crystal display as claimed in claim 9, wherein in each of the color filter units, two of the sub-pixel color filters are positioned end to end with respect to each other, and are aligned along different directions that are symmetrically opposite to each other.

12. The liquid crystal display as claimed in claim 9, wherein each of the color filter units comprises a red sub-pixel color filter, a green sub-pixel color filter, a blue sub-pixel color filter, and a white sub-pixel color filter.

13. The liquid crystal display as claimed in claim 12, wherein in each of the color filter units, the red sub-pixel color filter, the green sub-pixel color filter, the blue sub-pixel color filter, and the white sub-pixel color filter are arranged side by side in a single row.

14. The liquid crystal display as claimed in claim 12, wherein in each of the color filter units, the red sub-pixel color filter, the green sub-pixel color filter, the blue sub-pixel color filter, and the white sub-pixel color filter are arranged in a 2×2 matrix.

15. The liquid crystal display as claimed in claim 9, wherein each of the sub-pixel color filters defines a through hole.

16. The liquid crystal display as claimed in claim 9, wherein in each of the sub-pixel regions, the transmission region is surrounded by the reflection region.

17. The liquid crystal display as claimed in claim 9, wherein in each of the sub-pixel regions, the reflection region is surrounded by the transmission region.

18. A liquid crystal display, comprising:
a first substrate;
a second substrate;
a liquid crystal layer between the first and second substrates;
a plurality of color filter units formed at the first substrate, each of the color filter units being generally serpentine; and
a plurality of pixel electrodes formed at the second substrate at positions in one-to-one correspondence with the color filter units.

19. The liquid crystal display as claimed in claim 18, wherein each color filter unit includes four sub-pixel color filters each essentially serpentine.

20. The liquid crystal display as claimed in claim 18, wherein each color filter unit includes four sub-pixel color filters each essentially straight.
